(19) United States
(12) Patent Application Publication
(10) Pub. No.: US 2002/0196592 A1
(43) Pub. Date: Dec. 26, 2002

(54) Positive temperature coefficient resistivity protected power transformer

(76) Inventors: William W. Chen, Marion, IA (US); Gary T. Jones, Antioch, TN (US); Jay B. Ballard, Huntington, IN (US); E. J. Homier, Huntington, IN (US)

Correspondence Address: Larry I. Golden, Square D Company, 1415 South Roselle Road, Palatine, IL, 60067, US

(21) Appl. No.: 09/885,206

(22) Filed: Jun. 20, 2001

(51) Int. Cl. H02H 7/04

(52) U.S. Cl. 361/35

(57) ABSTRACT

The present invention provides a transformer having a positive temperature coefficient resistivity polymer element electrically coupled to either the primary or secondary winding of the transformer to provide protection against overcurrent, short circuit and thermal overheating conditions. Use of the positive temperature coefficient resistivity polymer element helps to further reduce the amount of space needed for electrical and thermal protection of the transformer while lowering manufacturing costs by eliminating the use of a fuse and fuse block. The positive temperature coefficient resistivity polymer element also provides an advantage to the end user in that the positive temperature coefficient resistivity polymer element does not require replacement, unlike prior art fuses, following an overcurrent, short circuit or thermal overheating event.

### BACKGROUND OF THE INVENTION

1. Field of the Invention

The present invention relates generally to the suppression of transient energy to transformers and more particularly to a polymer positive temperature coefficient resistivity (PPTC) element which protects power transformers from overload, short circuit and thermal overheating conditions.

2. Description of the Related Art

It is known in the general art that power transformers typically have to be protected from overload or overcurrent and short circuit conditions. Significant damage, such as insulation damage or fire, may occur to the transformer should an overload or overcurrent or short circuit condition occur.

Prior art devices used in overcurrent or short circuit protection of transformers typically include current limiting fuses, which interrupt all available currents above the fuse's threshold current and below the fuse's maximum interrupting rating.

A prior art apparatus in Olesak et al. (U.S. Pat. No. 4,810,991), entitled “ENCAPSULATED INTEGRAL FUSE BLOCK TRANSFORMER”, comprises a transformer assembly, having primary and secondary windings, a fuse block and means for mounting the fuse block to the transformer. Claimed advantages of the Olesak assembly over the prior art are the conservation of space on a panel board to which the transformer is mounted and the reduction of time required to assemble the Olesak apparatus, therefore, resulting in lower labor costs in the manufacture of the assembly.

As noted in the Olesak patent, labor costs and the amount of available space on the transformer which may be utilized for circuit protection are important factors in the manufacture of transformers. Current fuse and fuse block assemblies continue to require a significant amount of space and provide a significant disadvantage when integrating other circuitry or electrical components into a panel.

Another disadvantage with the use of a fuse and fuse block assembly is that it may only provide overcurrent and short circuit protection. Current fuse and fuse block assemblies fail to appreciate that thermal cut-off must occur in a power transformer that has become overheated by a source other than the thermal energy created during an overcurrent or short circuit situation. In such situations, a fuse does not provide protection from such overheating condition, thereby causing a degradation, and ultimate failure, of the transformer.

A further disadvantage to the fuse and fuse block system is that the fuse is not reusable and must be replaced after the occurrence of an overcurrent or short circuit event. Replacement of a fuse is an additional expense, a time consuming event and an inconvenience to users. Therefore, equipment manufacturers utilizing power transformers prefer an alternative to a fuse based protection system.

### SUMMARY OF THE INVENTION

The present invention provides a transformer having primary and secondary windings and a polymer positive temperature coefficient resistivity element electrically coupled to the primary or secondary winding of the transformer to provide protection against overcurrent, short circuit and overheating conditions.

The polymer positive temperature coefficient resistivity element is thermally and electrically connected to the coil body, preferably the primary winding, of the power transformer. Preferably, the polymer positive temperature coefficient resistivity element is placed in an area of the transformer prone to exhibit an increase in temperature. The resistance of the polymer positive temperature coefficient resistivity element dramatically increases upon the occurrence of an overcurrent, short circuit or overheating event, thereby reducing the current in the transformer to a minimal level. The resistance of the polymer positive temperature coefficient resistivity element increases so greatly that the current through the circuit drops dramatically after an overcurrent, short circuit or overheating event.

In another embodiment, a light emitting diode (LED), a P-N junction semiconductor device, which emits optical radiation when forward biased, is electrically coupled to the polymer positive temperature coefficient resistivity element. Upon activation of the polymer positive temperature coefficient resistivity element, voltage across the LED will be sufficient to illuminate it and thereby provide notice to maintenance personnel that a fault situation has occurred.

In yet another embodiment, a solenoid and mechanical switch are introduced into the power transformer and polymer positive temperature coefficient resistivity element circuitry. After activation of the polymer positive temperature coefficient resistivity element, an undesired current flow, leakage current, in the order of a few mill-ampere continues to flow through the power transformer and the polymer positive temperature coefficient resistivity element. This leakage current is of a sufficient magnitude to keep the polymer positive temperature coefficient resistivity element in the activated or tripped state. The solenoid and mechanical switch are introduced into the power transformer and polymer positive temperature coefficient resistivity element circuitry to interrupt all current flow following activation of the polymer positive temperature coefficient resistivity element.

Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1a illustrates a prior art power transformer utilizing a fuse and fuse block for protection of the transformer in overcurrent and short circuit conditions;

FIG. 1b is a schematic diagram of the prior art power transformer shown in FIG. 1a;

FIG. 2a is a power transformer utilizing a polymer positive temperature coefficient resistivity element for protection of the transformer in overcurrent, short circuit and thermal overheating conditions in accordance with a preferred form of the invention;

FIG. 2b is a schematic diagram of the preferred embodiment shown in FIG. 2a;

FIG. 3 is a schematic diagram of an alternative embodiment of the present invention wherein a light emitting diode is electrically connected to the polymer positive temperature coefficient resistivity element to provide a fault situation signal to maintenance personnel;

FIG. 4 is a schematic diagram of an alternative embodiment of the present invention wherein a solenoid and switch, each electrically connected to the polymer positive temperature coefficient resistivity element, provide total current interruption; and

FIG. 5 is a schematic diagram of an alternative embodiment of the present invention wherein a solenoid and switch, the solenoid electrically coupled to the polymer positive temperature coefficient resistivity element and the switch electrically coupled to the secondary winding, provide total current interruption.

### DETAILED DESCRIPTION OF THE PREFERRED EMBODIMENT

The present invention relates to apparatus and methods for protecting a power transformer during overcurrent, short circuit and overheating conditions. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

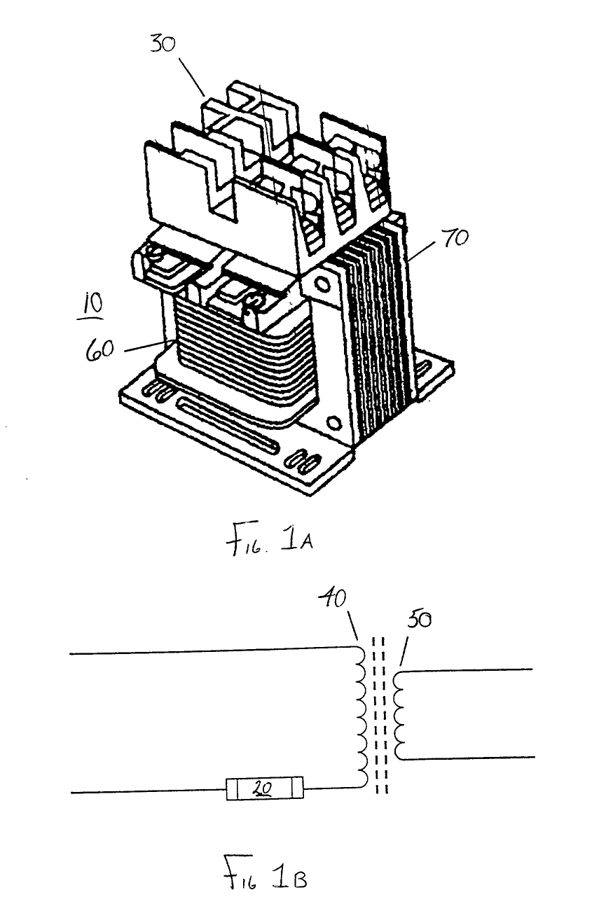

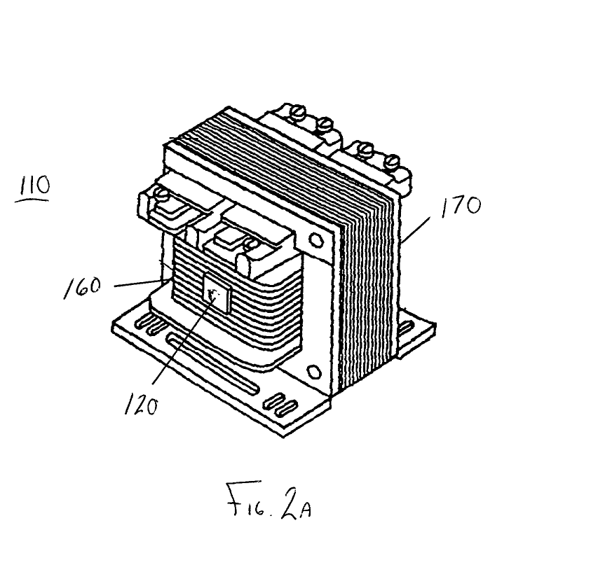

As stated above, prior art devices used in overcurrent or short circuit protection of transformers typically include current limiting fuses. FIG. 1(a) illustrates a prior art power transformer 10 utilizing a current limiting fuse (not shown), in combination with a fuse block assembly 30, as a protection means. FIG. 1(b) is a schematic of the prior art transformer 10 comprising a primary winding 40, a secondary winding 50 and a current limiting fuse 20 electrically connected to the primary winding 40 of the power transformer 10. A power source (not shown) is electrically connected to the primary winding 40 of the transformer 10. In FIG. 1(a), a fuse block assembly 30 is positioned atop a transformer coil body 60, comprising the primary winding 40 and the secondary winding 50, and a transformer core 70.

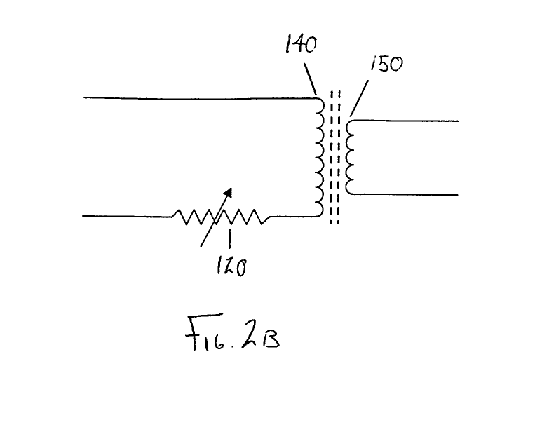

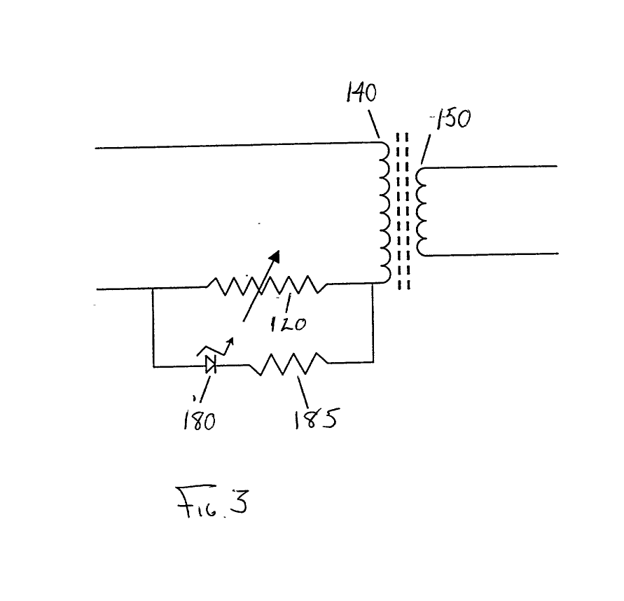

Referring to FIG. 2a, there is shown a preferred embodiment of the present invention, a polymer positive temperature coefficient resistivity (PPTC) protected power transformer 110. The present invention is a low cost, space saving solution to the fuse and fuse block protected power transformer. In addition to providing overcurrent and short circuit protection, the preferred embodiment provides overheating or thermal cut-off protection, which is not available with the prior art device shown in FIGS. 1(a) and 1(b).

For PPTC protected power transformers, there are three types of available protection: (1) overcurrent or overload protection; (2) short circuit protection; and (3) overheating or thermal cut-off protection. The PPTC material has a unique characteristic that allows its resistance to increase dramatically as its temperature increases over a certain value (i.e., 140° C.). The resistivity of a PPTC element at a temperature higher than 140° C. must be at least 100 times the resistivity of the element at ambient temperature.

In FIGS. 2a and 2b, the transformer core 170, comprising laminated steel sheets, is adjacent to the transformer coils 160, comprising the primary winding 140 and secondary winding 150. A power source (not shown) is electrically connected to the primary winding 140 of the transformer 110. The polymer positive temperature coefficient resistivity element 120 is wrapped around the coil body 160, specifically the primary winding, and is thermally attached to the coil body 160 and the insulating materials. The polymer positive temperature coefficient resistivity element 120 may be attached to the coil body 160 surface as shown in FIG. 2a. The polymer positive temperature coefficient resistivity element 120 may also be wrapped inside the coil body 160. In the preferred embodiment, the polymer positive temperature coefficient resistivity element 120 is placed in an area of the coil body 160 prone to exhibit an increase in temperature, thereby providing maximum protection (i.e., overcurrent, short circuit and thermal overheating) of the power transformer 110. The PPTC temperature is related to the ohmic heating caused by current flow through the polymer positive temperature coefficient resistivity element 120. Therefore, when the PPTC element 120 is electrically connected in the transformer circuitry, the transformer 110 temperature is controlled by the current flowing though it.

It is emphasized, however, that the present invention is not limited to polymer based materials. Polymer based materials simply exhibit the desired properties that are utilized in the present invention. Thus, other materials, such as ceramic-based materials (i.e., a BaTiO₃ ceramic) that provide for overcurrent, short circuit and thermal overheating protection may also perform adequately.

Under normal operations, current flow through the power transformer 110, more specifically, the coil body 160, will not generate sufficient ohmic heating to initiate operation of the PPTC element 120. However, when the transformer 110 is placed in an overcurrent situation, for example, the excess current will initiate operation of the PPTC element 120 within a predetermined time period. The resistance of the PPTC element 120 will dramatically increase upon activation, thereby reducing the current within the primary winding 140, for example, to a minimal value. The transformer 110 is consequently protected from the overcurrent by the PPTC element 120. When the PPTC protected transformer is under a short circuit situation, the large, short circuit current activates the PPTC element 120 within a few milli-seconds, thereby providing sufficient current limitation to the power transformer 110.

The PPTC element 120 may also be activated when overheated, for example, by an external heat source. An external heat source could include, for example, any other component or assembly in close proximity to the PPTC element 120. In a thermal overheating situation, the PPTC element 120 will become activated to protect the transformer 110 from further overheating which results in degradation, and ultimately destruction, of the power transformer 110.

In the above three fault situations, the PPTC element 120 will reset itself to its original state once the overcurrent, short circuit or overheating is removed and the power source is turned off.

In FIG. 2b, the PPTC element 120 is preferably connect to the primary winding 140 of the power transformer 110. Since the primary winding 140 draws much less current than the secondary winding 150 of the power transformer 110, the PPTC element 120 component size may be smaller for the primary winding 140 application than that for the secondary winding 150 application.

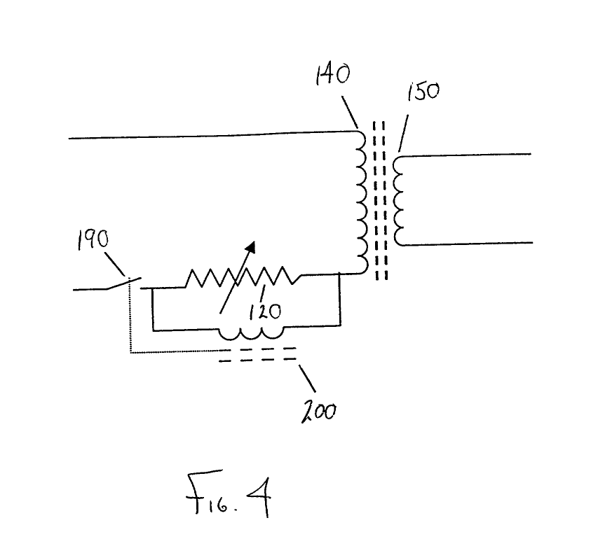

FIG. 3 is a schematic of an alternative embodiment of the present invention. In this embodiment, a light emitting diode (LED) 180 is connected in parallel with the PPTC element 120 and a resistor 185. The LED 180 may be mounted on a panel board (not shown), which would allow for easy observation. In the event that the PPTC element 120 is activated, the voltage across the LED 180 will be sufficient to illuminate the LED 180 and provide an indication to maintenance personnel that a fault situation has occurred.

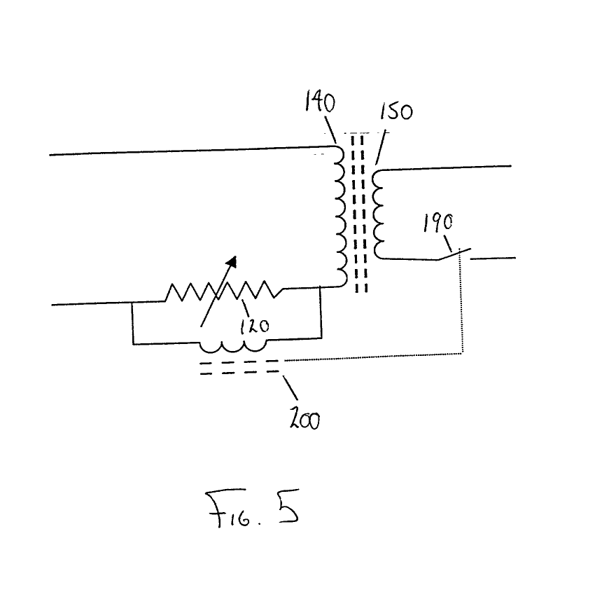

Upon activation of the PPTC element 120, a leakage current continues to flow through the PPTC element 120 and the transformer coil body 160. This leakage current typically is a few milli-ampere and may be sufficient to keep the PPTC element 120 in the activated state. Should an application require no leakage current, a mechanical switch 190 may be connected in series with the primary winding 140, as shown in FIG. 4, or with the secondary winding 150, as shown in FIG. 5, of the power transformer 110. The switch 190, which is normally closed during normal operations, is mechanically linked to a solenoid 200 that is connected in parallel with the PPTC element 120. As the PPTC element 120 is activated, a current will flow through the solenoid 200 thereby creating a magnetic field and energizing the solenoid 200 to open the switch 190 causing an interruption in current flow and elimination of any leakage current. The switch 190 should remain open after the PPTC element 120 is activated and until the fault is cleared. After the fault have been cleared, the switch 190 can be closed manually.

The foregoing description is directed to particular embodiments of the present invention for the purpose of illustration and explanation. It will be apparent, however, to one skilled in the art that many modifications and changes to the embodiment set forth are possible without departing from the scope and the spirit of the invention. It is intended that the following claims be interpreted to embrace all such modifications and changes.

What is claimed is:

1. A power transformer, comprising:
(a) a transformer coil body;
(b) a metallic core electrically connected to said transformer coil body; and
(c) a polymer positive temperature resistivity element electrically connected to said transformer coil body to limit current flow through said transformer coil body upon an occurrence of an activation event.

2. The power transformer of claim 1 wherein said activation event is a short circuit condition.

3. The power transformer of claim 1 wherein said activation event is an overcurrent condition.

4. The power transformer of claim 1 wherein said activation event is external heating of said transformer coil body.

5. The power transformer of claim 1 wherein said transformer coil body comprises a primary winding and a secondary winding of said transformer coil body.

6. The power transformer of claim 5 wherein said polymer positive temperature resistivity element is electrically connected to said primary winding of said transformer coil body.

7. The power transformer of claim 5 wherein said polymer positive temperature resistivity element is electrically connected to said secondary winding of said transformer coil body.

8. A power transformer, comprising:
(a) a transformer coil body;
(b) a metallic core electrically connected to said transformer coil body;
(c) a polymer positive temperature resistivity element electrically connected to said transformer coil body to limit current flow through said transformer coil body upon an occurrence of an activation event; and
(d) a light emitting diode electrically coupled to said polymer positive temperature resistivity element to signal activation of said polymer positive temperature resistivity element.

9. The power transformer of claim 8 wherein said activation event is a short circuit condition.

10. The power transformer of claim 8 wherein said activation event is an overcurrent condition.

11. The power transformer of claim 8 wherein said activation event is external heating of said transformer coil body.

12. The power transformer of claim 8 wherein said transformer coil body comprises a primary winding and a secondary winding of said transformer coil body.

13. The power transformer of claim 12 wherein said polymer positive temperature resistivity element is electrically connected to said primary winding of said transformer coil body.

14. The power transformer of claim 12 wherein said polymer positive temperature resistivity element is electrically connected to said secondary winding of said transformer coil body.

15. A power transformer, comprising:
(a) a transformer coil body;
(b) a metallic core electrically connected to said transformer coil body;
(c) a polymer positive temperature resistivity element electrically connected to said transformer coil body to limit current flow through said transformer coil body upon an occurrence of an activation event;
(d) a solenoid electrically connected in parallel with said polymer positive temperature coefficient resistivity element to create a magnetic field when current flows through said solenoid; and
(e) a switch mechanically linked to said solenoid and electrically connected in series with said transformer coil body, said switch activated into an open position to eliminate leakage current flow to said transformer coil body upon activation of said polymer positive temperature resistivity element and current flow through said solenoid.

16. The power transformer of claim 15 wherein said activation event is a short circuit condition.

17. The power transformer of claim 15 wherein said activation event is an overcurrent condition.

18. The power transformer of claim 15 wherein said activation event is external heating of said transformer coil body.

19. The power transformer of claim 15 wherein said transformer coil body comprises a primary winding and a secondary winding of said transformer coil body.

20. The power transformer of claim 19 wherein said polymer positive temperature resistivity element is electrically connected to said primary winding of said transformer coil body.

21. The power transformer of claim 19 wherein said polymer positive temperature resistivity element is electrically connected to said secondary winding of said transformer coil body.

22. A method of limiting current flow in a transformer, comprising:
electrically connecting a polymer positive temperature coefficient resistivity element in series with a primary winding of the transformer wherein said polymer positive temperature coefficient resistivity element increases its resistivity at least 100 times at ambient temperature upon an occurrence of an activation event.

23. The method of limiting current of claim 22 wherein said activation event is a short circuit condition.

24. The method of limiting current of claim 22 wherein said activation event is an overcurrent condition.

25. The method of limiting current of claim 22 wherein said activation event is external heating of said transformer.
